(19) United States
(12) Patent Application Publication
(10) Pub. No.: US 2015/0054390 A1
(43) Pub. Date: Feb. 26, 2015

(54) ELECTRICALLY DRIVEN MOTORCYCLE

(71) Applicant: Robert Bosch GmbH, Stuttgart (DE)

(72) Inventors: Norbert Martin, Achern (DE); Stefan Demont, Buehl (DE); Armin Stubner, Buehl-Altschweier (DE); Michel Dietrich, Ostwald (DE)

(21) Appl. No.: 14/390,832

(22) PCT Filed: Mar. 27, 2013
(86) PCT No.: PCT/EP2013/056545

§ 371 Date: Oct. 6, 2014

(30) Foreign Application Priority Data
Apr. 5, 2012 (DE) 10 2012 205 672.6

(51) Int. Cl. H02K 1/27; H02K 11/00; H02K 7/116

(52) U.S. Cl. CPC H02K 1/272; H02K 7/116; H02K 11/0073
USPC 310/68 R; 310/156.43; 310/75 R

(57) ABSTRACT

The invention relates to an electrically driven motorcycle (1) comprising at least one electrical machine (4), which has a stationary stator (6) and a rotatably mounted rotor (7), wherein said rotor (7) has a return ring (9) with a plurality of permanent magnets (8) distributed over the circumference thereof. According to the invention, the permanent magnets are arranged in the return ring (9) like spokes with alternating tangential magnetisation. The invention further relates to a method for operating such a motorcycle.

### BACKGROUND OF THE INVENTION

The invention relates to an electrically driven motorcycle with at least one electrical machine comprising a fixed stator and a rotatably mounted rotor, wherein the rotor comprises a return ring with a plurality of permanent magnets disposed thereon distributed over the circumference.

The invention further relates to a method for operating such a motorcycle.

Motorcycles of the above-mentioned type are known from the prior art. In particular, electric scooters are operated in the power class up to 4 kW, sometimes also up to 11 kW, frequently with gearless wheel hub motors on the rear wheel. These motors are generally brushless, electrically commutated motors. These comprise a stator with a generally high number of slots fixed to an axle. The rotor that interacts with the stator is disposed as a direct component of the rim or fixed to the rim and typically comprises a ring of permanent magnets disposed on an iron return ring, especially rare earth magnets in a large number of poles. The permanent magnets are normally disposed laterally adjacent to each other on the inside of the return ring in this case. The quantity of rare earth magnets used amounts to the largest part of the total costs of the drive.

It is a disadvantage of said embodiment that the motor can only be usefully operated in the armature operating range. Once the voltage induced by the rotation of the rotor in the stator phases reaches the maximum phase voltage available from the operating voltage source, the electric motor turns itself off and the torque reduces to zero, whereby the possible maximum revolution rate is limited.

### SUMMARY OF THE INVENTION

The motorcycle according to the invention has by contrast the advantage that for one thing it can be manufactured economically because the use of the expensive rare earth magnets can be omitted. Owing to the special topology of the motor according to the invention, the usable torque range and revolution rate range of the motorcycle are extended without significantly increasing the size of the electrical machine. The motorcycle according to the invention is characterized in that the permanent magnets of the electrical machine are disposed in the form of spokes with alternating tangential magnetization. Owing to the spoke-like disposition in the return ring, adjacent permanent magnets are oriented radially relative to the axis of rotation of the rotor and therefore in a V formation relative to each other in the material of the return ring, giving the electrical machine a pronounced salience or prominence of the magnetic flux of the rotor. Owing to the pronounced salience it is now possible to utilize or produce an additional reluctance torque in the entire operating range by means of suitable pre-commutation or post-commutation. Furthermore, the possibility of active field weakening is opened up by means of pre-commutation, whereby the usable revolution rate range is considerably extended up above the pure armature operating range and also an additional reluctance torque is made usable in the field weakening range that can now be used. Preferably, the motorcycle is suitably controlled such that an additional reluctance torque is produced by means of pre-commutation or post-commutation as required. Moreover, only low production costs are incurred because in particular the expensive rare earth magnetic material can be omitted. Return ring segments, which are magnetically connected to the permanent magnets, thus lie between adjacent permanent magnets.

Particularly preferably, the radial end surfaces of the permanent magnets facing the stator are each at least substantially exposed, preferably completely exposed. As a result of the material of the return ring being disposed between adjacent permanent magnets, the previously described salience is guaranteed. A preferred topology with twelve slots and five pairs of poles comprises a particularly high winding factor of 94% and results in a sufficiently low engagement torque for the target application. The spoke-like arrangement of the permanent magnets results in a flux concentration that is radially effective in the stator direction with the already mentioned pronounced salience.

Particularly preferably, the radial end surfaces of the permanent magnets facing away from the stator are at least substantially exposed, preferably completely exposed. A return path via the return material of the return ring on the inside of the rotor is therefore prevented. Preferably, both the radial end surfaces of the spoke-like oriented permanent magnets facing the stator and also the radial end surfaces facing away from the stator are exposed, so that the return ring is essentially discontinuous in the region of the permanent magnets and is formed by the return ring segments between adjacent permanent magnets. The return ring preserves the function of the magnetic return path for the stator flux across said division, but stray magnetic flux between the front and rear of individual magnets is prevented by the division, otherwise the desired flux concentration would no longer be available. If it is structurally necessary, then the radial end surfaces facing the stator or the radial end surfaces facing away from the stator can be formed by covering webs of the return ring, which extend from one return ring segment to the next, wherein there is preferably still an air gap between the connecting webs and the radial end surfaces. The webs are made narrow here such that they rapidly magnetically saturate so that the stray flux losses are minimized.

According to one advantageous development of the invention, it is provided that each return ring segment of the return ring disposed between adjacent permanent magnets terminates flush with the surfaces of the permanent magnets facing the stator. The acoustics of the electrical machine are improved thereby because less wind noise or only a little wind noise occurs during operation.

Particularly preferably, the permanent magnets are ferrite magnets. These are less expensive to obtain and therefore result in a less expensive design of the motorcycle.

Particularly preferably, the permanent magnets in the return ring when looking in the circumferential direction, i.e. on the mutually facing sides of adjacent permanent magnets, are completely covered by the material of the return ring in order to achieve a good concentration of magnetic flux. Moreover, the introduction of the pronounced salience of the electrical machine, which is preferably in the form of an electrically commutated synchronous motor, in combination with field-oriented regulation enables a less complex, sensorless rotor position detection by measuring the impedance of the motor, e.g. by means of the injection of a high frequency signal into the stator and measuring the inductive response.

According to one advantageous development of the motorcycle, it is provided that a gearbox, especially a spur gearbox or planetary gearbox, is connected between the electrical machine and a drive wheel of the motorcycle. The gearbox can be integrated within the motorcycle without problems because of the special topology of the motor, which only has a small size. In particular, the integration of a spur gearbox optimized for the fraction application can thus be achieved. Although combination with a planetary gearbox is also possible, a spur gearbox with an intermediate shaft is proposed for this application because ratios of twice the magnitude can be achieved in a technically robust manner with this type of gearbox with a comparable installation space and significantly lower complexity. The gearbox can be designed to enable the selection of multiple gears.

Advantageously, the electrical machine comprises a power electronics unit for its control. Particularly preferably, the power electronics unit is disposed in a single-sided swingarm supporting the drive wheel of the motorcycle. The single-sided swingarm can be directly used by the power electronics unit as a cooling surface. It is of course also conceivable to provide the drive wheel on a dual-sided swingarm and to integrate the power electronics accordingly in one arm, in the other arm or in both arms of the dual-sided swingarm.

The proposed topology of the electrical machine in combination with the integrated gearbox leads to high efficiencies and hence to low loss of power densities of the motorcycle, so that at least in most application cases cooling fins on the electrical machine itself can be omitted, resulting in significant degrees of freedom for the design of a single-sided or dual-sided swingarm.

The method according to the invention described above for operating the motorcycle is characterized in that the electrical machine is controlled with pre-commutation or post-commutation in order to produce an additional reluctance torque. Advantageous developments and advantages are the result of the previously described subject matters.

### BRIEF DESCRIPTION OF THE DRAWINGS

The invention will be explained below using the figures. In the figures

FIG. 1 shows a motorcycle in a perspective representation,

FIGS. 2A and 2B show the salience of magnetic fluxes of an electrical machine of the motorcycle,

FIG. 3 shows an equivalent circuit diagram of virtual inductances of the electrical machine,

FIG. 4 shows an advantageous embodiment of the electrical machine in a sectional representation,

FIG. 5 shows the electrical machine in a perspective representation,

FIG. 6 shows a comparison of virtual inductances of the electrical machine and

FIG. 7 shows a drive unit of the motorcycle in a perspective representation.

### DETAILED DESCRIPTION

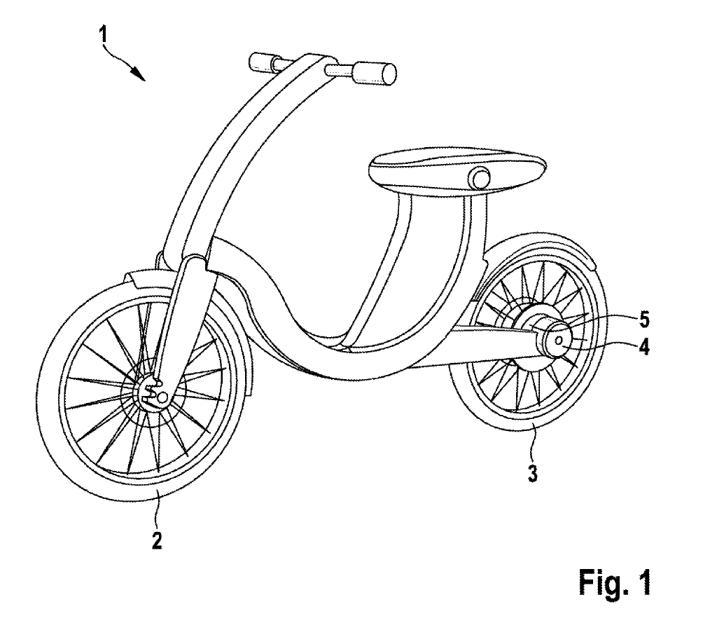

FIG. 1 shows a perspective representation of an electrically driven motorcycle 1, whose front wheel 2 is steerable and whose rear wheel 3 can be driven by an electrical machine 4 that is connected to the rear wheel 3 by a gearbox 5. The electrical machine 4 comprises a fixed stator 6 and a rotatably supported rotor 7, wherein the rotor 7 is disposed and oriented coaxially to the stator 6.

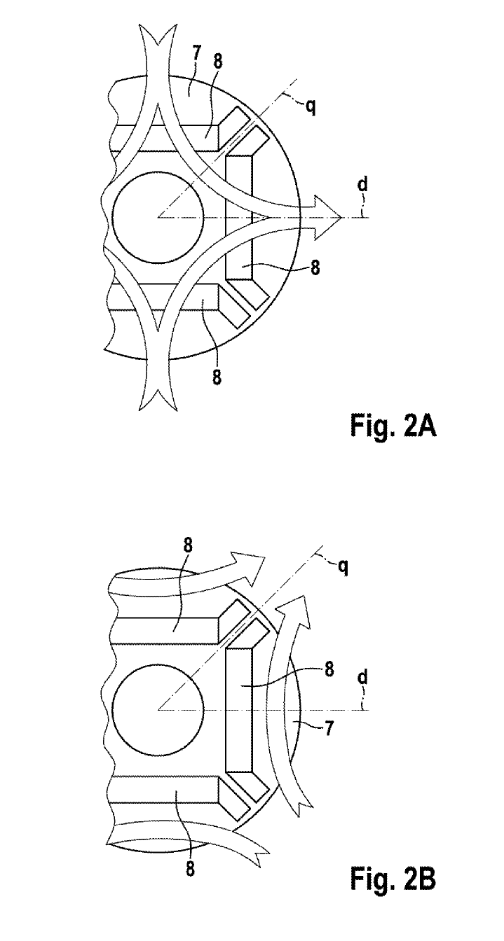

The rotor 7 is usually provided with a plurality of juxtaposed permanent magnets, typically rare earth magnets, which are disposed on a return ring 9. The usual construction method has the disadvantage that known rotors have virtually no pronounced salience. The term salience will be explained in detail with reference to FIGS. 2A and 2B. In the rotor-fixed coordinate system of a permanent-magnet synchronous machine, the so-called q-axis describes the direction of a magnetic flux of a return ring 9 produced by the stator current perpendicular to the stimulation produced by the permanent magnets 8, as shown in FIGS. 2A and 2B. The d-axis refers to the direction of the magnetic flux primarily produced by the permanent magnets 8.

When controlling the electrical machine (without pre-commutation) the stator 6 produces no flux component in the d-direction. The flux in the d-direction and the q-direction and the motor torque M_{Mi} are calculated, e.g. for a three-phase motor, according to:

$${Ψ}_{d} = {L}_{d} \cdot {I}_{d} + {Ψ}_{PM} = {Ψ}_{PM} {\vert}_{Id = 0} \\ {Ψ}_{q} = {L}_{q} \cdot {I}_{q}$$

$${M}_{Mi} = \frac{3}{2} \cdot {Z}_{p} \cdot {Ψ}_{PM} \cdot {I}_{q}$$

Wherein L_{d}, L_{q} represent the instantaneous, virtual stator inductances in the d-direction and the q-direction, Zₚ corresponds to the number of pole pairs, and Ψ_{d}, Ψ_{q} and Ψ_{PM} are the respective flux components in the d-direction and the q-direction and of the permanent magnets PM.

The virtual inductances L_{d} and L_{q} arise in a motor topology by reverse calculation from a ring integral along the magnetic fluxes considered. Because the magnetic permeability of ferromagnetic materials is almost equal to that of air, it can be seen that for motors with permanent magnets in the typical surface arrangement the virtual inductances L_{d} and L_{q} are almost equal, wherein it is irrelevant whether an air gap is provided between the permanent magnets or whether as usual the permanent magnets are applied laterally adjacent to each other.

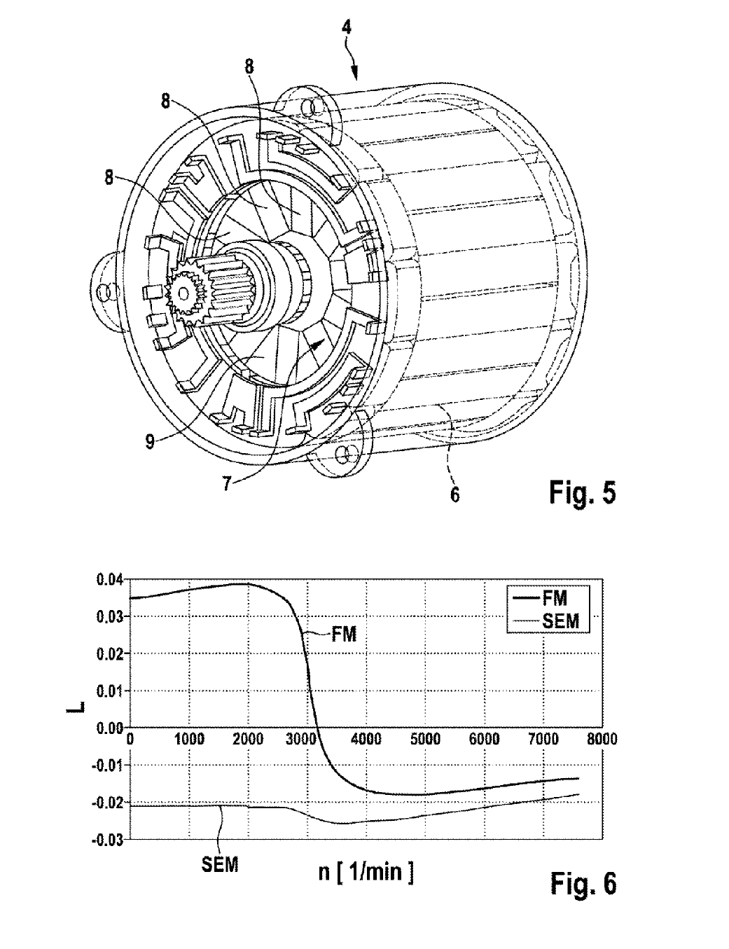

Advantageously, the permanent magnets of the electrical machine 4 are at least partially buried, as shown in FIGS. 4 and 5. Owing to the advantageous arrangement of the permanent magnets within the return ring 9 supporting the permanent magnets 8, the ring integrals provide different values for L_{d} and L_{q}. Because L_{d} and L_{q} describe instantaneous virtual inductances, these are typically also independent of the operating state of the electrical machine 4, especially of its revolution rate.

If a time-invariant phase advance angle from the perspective of the rotor-fixed coordinate system is advantageously selected for the electrical machine 4 of such a design, which does not cause the L_{d} components to disappear, then the operating variables flux Ψ_{d}, Ψ_{q}, Ψ_{PM}, phase voltage U_{d}, U_{q}, torque M_{Mi}, electrical rotation rate Ω_{L}, the number of pole pairs Zₚ and the sum of the phase currents Iₐ, I_{b}, I_{c} are given as follows:

$${Ψ}_{d} = {L}_{d} \cdot {I}_{d} + {Ψ}_{PM}$$

$${Ψ}_{q} = {L}_{q} \cdot {I}_{q}$$

$${U}_{d} = {R}_{1} \cdot {I}_{d} + \frac{d {Ψ}_{d}}{d t} - {Ω}_{L} \cdot {Ψ}_{q}$$

$${U}_{q} = {R}_{1} \cdot {I}_{q} + \frac{d {Ψ}_{q}}{d t} + {Ω}_{L} \cdot {Ψ}_{d}$$

$${M}_{Mi} = \frac{3}{2} \cdot {Z}_{p} \cdot ( {Ψ}_{PM} \cdot {I}_{q} + ( {L}_{d} - {L}_{q} ) \cdot {I}_{d} \cdot {I}_{q} )$$

$${Ω}_{L} = {Z}_{p} \cdot {Ω}_{m}$$

$${I}_{a} + {I}_{b} + {I}_{c} = 0$$

The formulas apply to a sinusoidal commutation of the electrical machine 4. An electrically less complex block commutation would add higher harmonic terms to the equations but would not change the fundamental relationships.

An additional torque component resulting from the at least partially buried arrangements of the permanent magnets 8 in the return ring 9, the so-called reluctance torque (L_{d}−L_{q})*I_{d}*I_{q}, is added to the torque. It is now possible to select a set of optimized control parameters for any static or dynamic operating state of the motor by optimizing the control, for example for MTPA (Max Torque Per Ampere=maximum torque per ampere) or MTPV (Max Torque Per Volt (maximum torque per volt)).

At the same time a component L_{d}*I_{d} is added to the permanent stimulation of the electrical machine. With pre-commutation (I_{d}<0) the stimulation flux in the d-direction also reduces and with it the induced electromotive reverse voltage, whereby higher revolution rates are enabled for the motor.

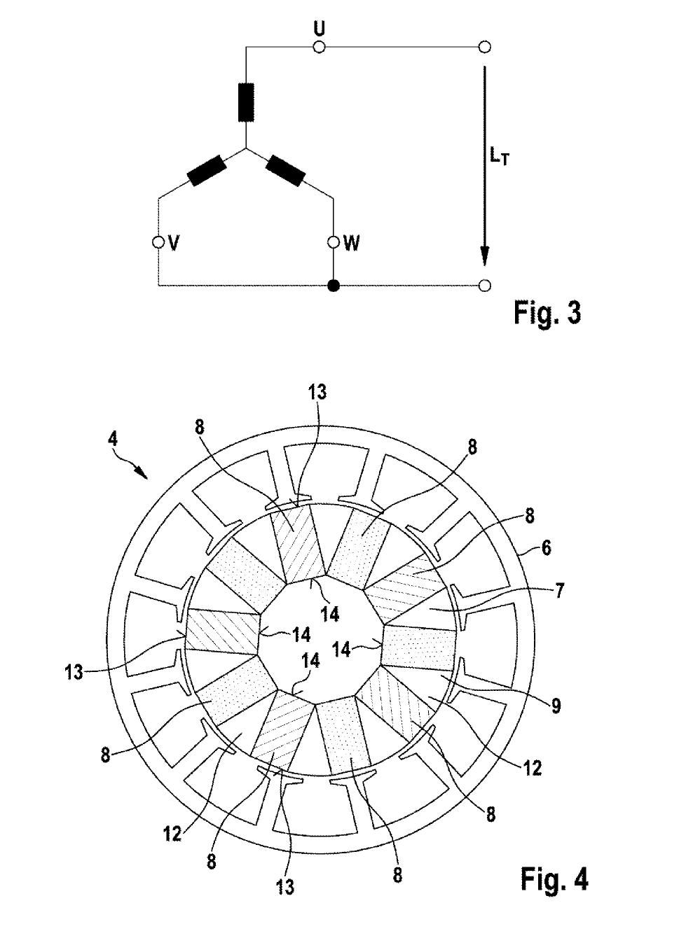

The measurable terminal inductance L_{T} of a 3-phase motor with the virtual inductances with the arrangement shown in FIG. 3 is calculated as follows:

$${L}_{T} = \frac{3}{2} ( \frac{{L}_{d} + {L}_{q}}{2} + \frac{{L}_{d} - {L}_{q}}{2} \cdot cos 2 θ )$$

Here θ describes the electrical rotor position angle of the rotor 7. With pronounced salience the measured terminal inductance oscillates between 3/2 L_{d} and 3/2 L_{q} with the cosine of the position angle. An additional sign identification of the difference of the intervals 0−π and π−2π is sufficient for unique identification of the rotor position. When measuring the terminal inductance, for example by modeling a high frequency signal with specified d/q-orientation to the stator voltages and separate determination of the resulting phase currents I_{d} and I_{q}, the ambiguity of the cosine can also be resolved for this purpose without additional sensors by a suitable iteration method and thus a sensorless rotor position angle detection can be carried out.

FIGS. 4 and 5 show an advantageous exemplary embodiment of the electrical machine 4 of the motorcycle 1, wherein FIG. 4 shows the electrical machine 4 in a sectional representation and FIG. 5 shows the electrical machine in a perspective representation.

FIG. 4 shows the electrical machine 4, which is coupled via the gearbox 5 to the rim of the rear wheel 3. The electrical machine 4 comprises a fixed stator 6 and a rotatably supported rotor 7. The rotor 7 comprises a return ring 9 in which permanent magnets 8 are disposed in a spoke-like manner with alternating magnetization direction, so that a flux concentration effective in the stator direction is produced. The permanent magnets 8 are radially oriented in this respect relative to the axis of rotation of the rotor 7. The rotor 7 is designed in this case such that the permanent magnets 8 are disposed with their radial end surfaces 13 facing the stator and their radial end surfaces 14 facing away from the stator exposed. The permanent magnets 8 are thus not radially enveloped by material of the return ring 9. Magnetic stray flux is thereby prevented. The return ring 9 consists in the present exemplary embodiment of a plurality of return ring segments 12, each of which is provided between adjacent permanent magnets 8. The return ring segments 12 can e.g. be joined to the respective permanent magnets 8 by gluing. In order to structurally strengthen the return ring 9, it is also conceivable to provide a connecting web between adjacent return ring segments 12 on the inside and/or on the outside in each case, wherein the connecting web connects the adjacent return ring segments to each other and thereby radially covers the respective permanent magnets lying between them. This is to ensure that there is still an air gap or an air pocket between the permanent magnets and the connecting webs in each case in order to prevent or reduce stray magnetic flux. Advantageously, the connecting webs are made narrow here such that they rapidly saturate magnetically. Advantageously, the permanent magnets 8 are in the form of ferrite magnets. Owing to the selected topology with e.g. twelve slots and five pairs of poles, a particularly high winding factor is achieved at 94%, which results in sufficiently small engagement torques for the target application in the motorcycle 1.

Owing to the buried arrangement of the permanent magnets 8 in the material of the return ring 9, the previously described pronounced salience of the electrical machine 4 is achieved.

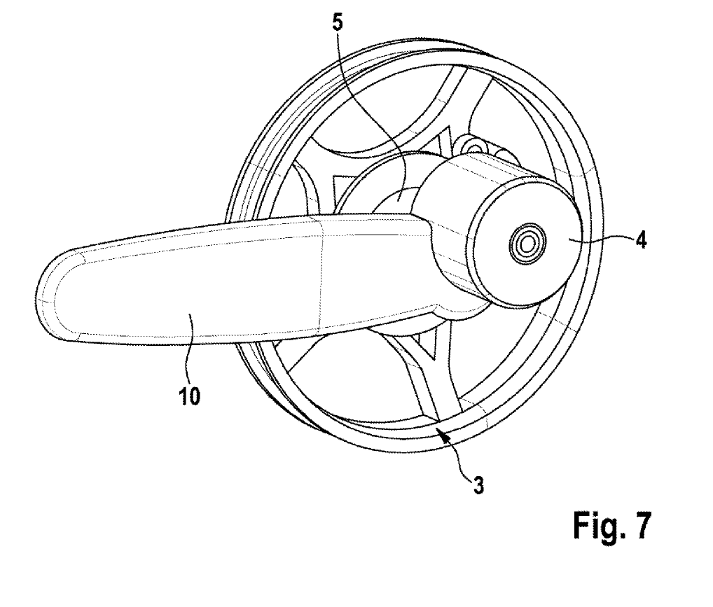

FIG. 6 shows in the diagram a comparison of the difference of the inductances L_{d}-L_{q} when using ferrite magnets (FM) and rare earth magnets (SEM) for the permanent magnets 8 against the revolution rate n of the electrical machine 4. Owing to the use of the ferrite magnets, a sign change is achieved in the region of the transition from the armature operating range to the field weakening mode. Owing to the buried arrangement of the permanent magnets 8, the difference of the inductances (L_{d}−L_{q}) is <0. Because pre-commutation produces negative phase currents I_{d} and positive phase currents I_{q} by definition, a useful positive torque of (L_{d}−L_{q})*I_{d}*I_{q} that is additional to the torque of the electrical machine is produced by pre-commutation in the field weakening region.

In the armature operating range, the electrical machine has a positive inductance difference (L_{d}−L_{q})>0, which enables the use of a significant reluctance torque owing to post-commutation. This can be used both to improve the efficiency in the region and also to achieve a power boost above the nominal design, for example to drive up a curb edge.

As already mentioned, the electrical machine 4 is connected via a gearbox 5 to the rim or to the rear wheel 3 in an arrangement close to the wheel or mounted on the wheel. Owing to the proposed motor topology, a small size of the electrical machine 4 with approximately square longitudinal section is enabled, which allows problem-free integration of a spur gearbox. In principle, the design of the gearbox 5 as a planetary gearbox would also be conceivable, but a spur gearbox with an intermediate is proposed for this application because twice the gear ratio can be provided in a technically robust manner with such a gearbox with comparable installation space and considerably lower complexity. The spur gearbox with an intermediate shaft also provides the necessary decoupling between the introduced wheel forces of the vehicle and the torque transfer path.

The gearbox 5 can be designed for multiple gear selection. An embodiment of the gearbox 5 with two-stage shifting has proved to be particularly advantageous. The introduction of a freewheel for the simple freewheeling mode of the motorcycle 1 is also possible as well as gears acting in both directions, which enables the recovery of braking energy.

The modular design of the drive system of the motorcycle 1 that is still used despite the integration option also enables the use of the electrical machine in other structural variants of the motorcycle 1, wherein the electrical machine 4 can also be connected to other torque and speed converters and can also be provided with a fixed mounting on the frame. With a mounting fixed to the frame the electrical machine 4 could be connected to the drive wheel 3 via a suitable gearbox or a traction drive.

FIG. 7 shows the wheel-fixed mounting of the electrical machine 4 on the rear wheel 3 or on its rim already indicated in FIG. 1. FIG. 7 shows the construction of the drive system of the motorcycle 1 with the electrical machine 4 and the integrated gearbox 5, which are directly connected to a single-sided swingarm 10 of the motorcycle. The power electronics unit of the electrical machine 4 is advantageously integrated within the single-sided swingarm 10 and uses the same as a cooling element or as a cooling surface. In an amended arrangement of the electrical machine 4 and the gearbox 5 relative to each other, integration within a dual-sided swingarm is of course also conceivable.

The proposed topology of the electrical machine 4 in combination with the integrated gearbox 5 results in such high efficiencies and thus in such low power density losses that cooling fins on the electrical machine 4 itself can be omitted, whereby considerable degrees of freedom are made available for the design of the single-sided swingarm or the dual-sided swingarm.

The drive unit, as shown in FIG. 7, fulfills the requirements for a drive with minimal complexity in the form presented here owing to a combination of the motor topology with high salience and the control method adapted thereto by means of pre-commutation and post-commutation, which is especially suitable for use as a drive mounted close to the wheel of the electrically operated motorcycle 1. Owing to said topology, e.g. an operating voltage range below 60 Volts can be achieved with airstream cooled rare earth-free motors with power up to e.g. four kilowatts with less than five kilograms of active mass. The additional reluctance torque is produced owing to the pre-commutation in a synchronous mode of the electrical machine in the field weakening region. Owing to post-commutation in the synchronous mode in the armature operating range, an additional reluctance torque is likewise used to increase the torque.

1. An electrically driven motorcycle (1) with at least one electrical machine (4) having a fixed stator (6) and a rotatably supported rotor (7), wherein the rotor (7) comprises a return ring (9) with a plurality of permanent magnets (8) disposed thereon and distributed over a circumference, characterized in that the permanent magnets are disposed in the return ring (9) in a spoke-like manner with alternating tangential magnetization.

2. The motorcycle as claimed in claim 1, characterized in that radial end surfaces (13) of the permanent magnets (8) facing the stator (6) are at least substantially exposed.

3. The motorcycle as claimed in claim 1, characterized in that radial end surfaces (14) of the permanent magnets (8) facing away from the stator are at least substantially exposed.

4. The motorcycle as claimed in claim 1, characterized in that a return ring segment (12) of a return ring (9) disposed between adjacent permanent magnets (8) terminates flush at least with end surfaces (13) of the permanent magnets (8) facing the stator (6).

5. The motorcycle as claimed in claim 1, characterized in that the permanent magnets (8) are ferrite magnets.

6. The motorcycle as claimed in claim 1, characterized in that when viewed in a circumferential direction the permanent magnets (8) in the return ring (9) are completely covered by material of the return ring (9).

7. The motorcycle as claimed in claim 1, characterized in that a gearbox (5) is connected between the electrical machine (4) and a drive wheel (3) of the motorcycle (1).

8. The motorcycle as claimed in claim 1, characterized in that a power electronics unit of the electrical machine (4) is disposed in a single-sided swingarm (10) supporting the drive wheel (3).

9. A method for operating a motorcycle (1) as claimed in claim 1, characterized in that the electrical machine (4) is controlled with a pre-commutation or a post-commutation for producing a reluctance torque.

10. The motorcycle as claimed in claim 1, characterized in that a spur gearbox or a planetary gearbox is connected between the electrical machine (4) and a drive wheel (3) of the motorcycle (1).

11. The motorcycle as claimed in claim 2, characterized in that radial end surfaces (14) of the permanent magnets (8) facing away from the stator are at least substantially exposed.

12. The motorcycle as claimed in claim 11, characterized in that a return ring segment (12) of a return ring (9) disposed between adjacent permanent magnets (8) terminates flush at least with end surfaces (13) of the permanent magnets (8) facing the stator (6).

13. The motorcycle as claimed in claim 12, characterized in that the permanent magnets (8) are ferrite magnets.

14. The motorcycle as claimed in claim 13, characterized in that when viewed in a circumferential direction the permanent magnets (8) in the return ring (9) are completely covered by material of the return ring (9).

15. The motorcycle as claimed in claim 14, characterized in that a gearbox (5) is connected between the electrical machine (4) and a drive wheel (3) of the motorcycle (1).

16. The motorcycle as claimed in claim 15, characterized in that a power electronics unit of the electrical machine (4) is disposed in a single-sided swingarm (10) supporting the drive wheel (3).

17. A method for operating a motorcycle (1) as claimed in claim 16, characterized in that the electrical machine (4) is controlled with a pre-commutation or a post-commutation for producing a reluctance torque.
